(19) United States
(12) Patent Application Publication
(10) Pub. No.: US 2022/0029205 A1
(43) Pub. Date: Jan. 27, 2022

(54) MULTICAVITY ELECTRIC POWER ACCUMULATOR

(71) Applicant: Antonio Caloro, Giurdignano (IT)

(72) Inventor: Antonio Caloro, Giurdignano (IT)

(21) Appl. No.: 17/297,281

(22) PCT Filed: Nov. 29, 2019
(86) PCT No.: PCT/IB2019/060316

§ 371 Date: May 26, 2021

(51) Int. Cl. H01M 10/42; H01M 50/112; H01M 50/77

(52) U.S. Cl. CPC H01M 10/4214; H01M 50/77; H01M 50/112

(57) ABSTRACT

An accumulator comprising an outer insulating case configured for accommodating an electrolyte internally to which there is contained, in addition to said electrolyte, an inner block characterized in that said inner block has a geometrical structure formed of a plurality of hollow cells communicating with each other to form a alveolar structure, every hollow cell comprising a wall wherein at least one hole is derived configured in such a way as to put the volume internal to said hole in communication with the volume external thereto, in that said block is formed of an alternation of conductive material regions and insulating material regions integral and alternating with each other to form electrodes and separators, and in that said geometrical structure formed of a plurality of hollow cells communicating with each other is uninterrupted in correspondence with the separation surfaces between said conductive material regions and said insulating material regions.

The present patent application for an industrial invention patent relates to an electric power accumulator.

More specifically, the present invention relates to an electrochemical accumulator comprising a plastic case containing a plurality of multicavity regions operating as lead electrodes, alternating with regions operating as separator elements; said system of regions and cavities makes it possible to achieve all characteristics necessary for a continuous operation of the accumulator in one body.

This type of accumulators can be configured for operating in adverse climatic conditions or for having a useful life of the product definitely exceeding ten years, for handling big electric loads as well as for providing a big availability of electric power.

Numerous ways are known in the present state of the art for implementing secondary (or rechargeable) cells wherein the anode, the cathode, and the separator are realized in such a way as to present, internally thereto, holes or connection ducts in which an electrolyte can flow.

An example, amongst many others, is described in WO2017/055984, which discloses an accumulator wherein the anode, the cathode, and the separator are formed on the inner surfaces of a support substrate in which a plurality of cavities is present.

Another example is illustrated in U.S. Pat. No. 8,237,538 which discloses a battery wherein a conductive material is deposited on a monolithic and porous structure featuring a porosity in a range from 74 to 99%.

Another example is described in US 2008/0176139 which discloses a battery equipped with fibrous electrodes.

The patent document U.S. Pat. No. 3,532,557 describes a lead battery comprising a polypropylene plastic case subdivided into a plurality of cell compartments and a plurality of partition walls integrally connected to said case; every compartment is provided with a plurality of electrode and separator regions, forming cell units. Every partition wall is provided with a hole through which the electrolyte can flow between the cell compartments. The battery also comprises exhaust holes for allowing gases to discharge to outside the case.

The patent document U.S. Pat. No. 4,735,873 describes a lead battery containing a plastic case containing a plurality of hollow cells, each of which comprises a plurality of walls operating as cell separators, provided with a plurality of through holes which allow the electrolyte to freely pass from one cell to the others. The hollow cells are alternatively filled with balls of negative and positive active materials in a strict contact with the surface of the walls of the hollow cell separator.

These examples and many others known in the present state of the art are still affected by a number of technical drawbacks, including the absence of measures aiming at recovering and continuing to use that part of the electrodes (active material) which, in use, tends to precipitate and to accumulate on the case bottom.

Also, in the embodiments known in the present state of the art no measures are known that allow to integrate the separators internally to the structure of an accumulator in a geometrically efficient and structurally effective manner and to optimize the ratio of its volume to the surface of the electrodes.

Also, no technical measures are known in the present state of the art that allow to efficiently cool or heat an accumulator during its operation, because no temperature stabilization systems are known in the present state of the art that are capable of operating in a capillary manner inside the accumulator body and in particular in a vascular manner inside the electrodes, the separators, or the case.

An object of the invention according to the present patent application is therefore to provide an electric power accumulator that overcomes the technical drawbacks of the embodiments known in the present state of the art, and in particular an electric power accumulator that: allows to optimize the ratio of the accumulator volume to the electrode surfaces, thus allowing to provide accumulators featuring a greater capacity, dimensions being equal; allows to integrate the separators and the electrodes in one structure, so that the separators can operate as separation elements between the individual electrodes as well as support elements contributing to support the weight of the accumulator; by virtue of its own inner geometry, allows to recover and to continue to use that part of the electrodes (active material) which, in use, tends to precipitate and accumulate on the case bottom; allows an effective cooling/heating of the accumulator thus obviating the well-known problem of stratification.

The invention achieves the predetermined objects, in that it is an electric power accumulator provided with an outer insulating case configured for accommodating an electrolyte internally to which there is contained, in addition to said electrolyte, a block comprising a structure formed of a plurality of regions provided with cavities communicating with each other to form an alveolar structure; every cavity comprises a wall wherein there is derived at least one hole configured in such a way as to put the volume internal to said wall in communication with the volume external thereto.

Said inner block is formed of an alternation of conductive material regions and insulating material regions, integral with and alternating with each other so as to form electrodes and separators, whereas the region-based geometric structure, formed of a plurality of cavities communicating with each other, is an uninterrupted in correspondence with the surfaces separating the conductive material regions from the insulating material regions.

These advantages and others will be apparent from the detailed description of the invention that is presented below with reference to the attached figures from 1 to 4, which illustrate respectively:

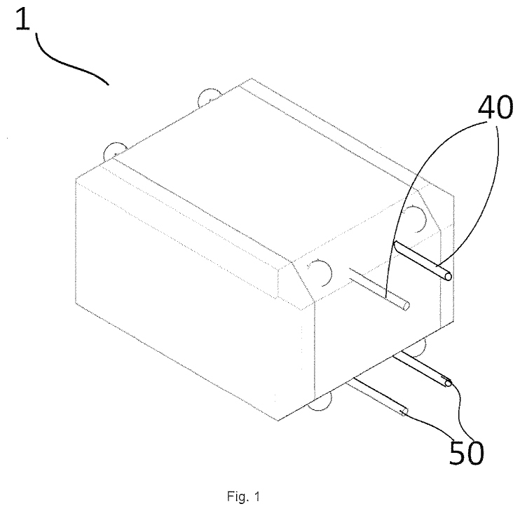

FIG. 1—an axonometric outside view of the accumulator according to the invention;

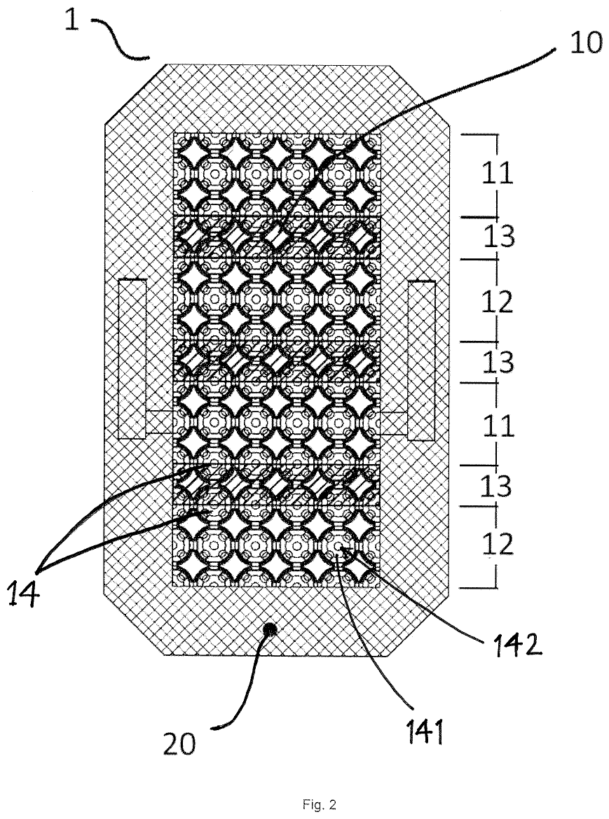

FIG. 2—a horizontal cross-sectional view of the accumulator of FIG. 1 showing the intercommunicating cavities;

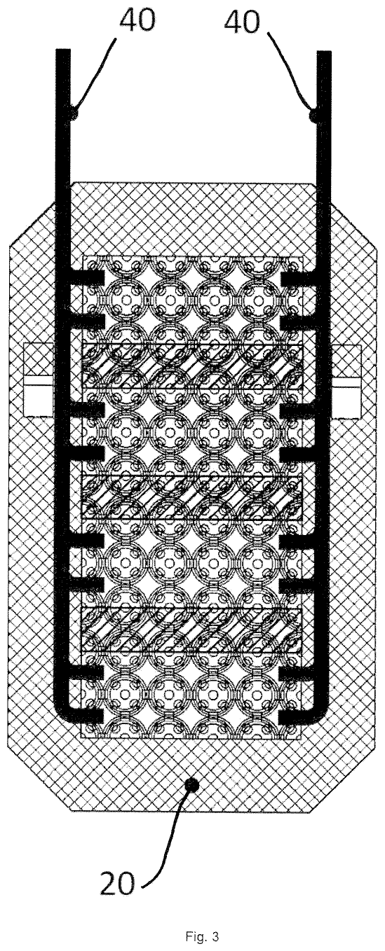

FIG. 3—a horizontal cross-sectional view of the accumulator of the previous figures showing the communication ducts between the inside of the accumulator, in which an electrolyte flows, and the outside of the accumulator;

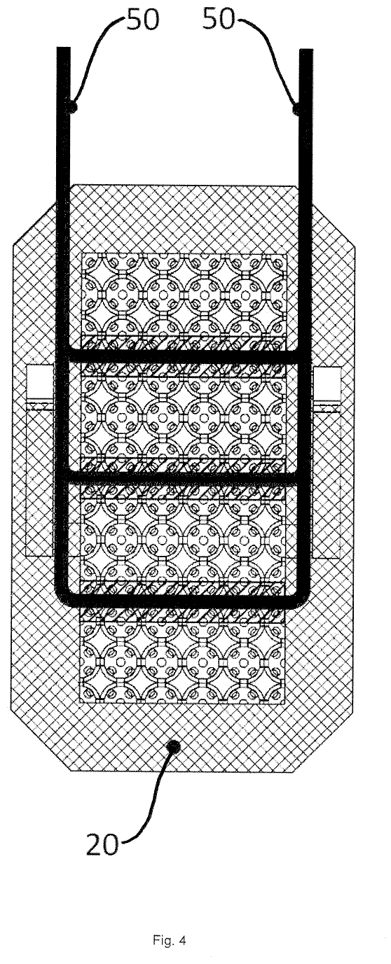

FIG. 4—a horizontal cross-sectional view of the accumulator of FIG. 1, showing the ducts that defines a volume, separated from that internally to which an electrolyte can flow, in which a second liquid can flow.

As shown in the figures, an accumulator 1 according to the invention comprises an inner block 10 comprising a plurality of positive electrodes 11, negative electrodes 12, and separators 13 contained inside an outer case 20.

As shown in FIG. 2, the inner block 10 comprises a geometrical structure formed of a plurality of cavities 14 communicating with each other.

The block 10 is formed of an alternation of a conductive material, which forms the electrodes 11, 12, and an insulating material, which forms the separators 13 of the accumulator. For explanatory non-limitative purposes only, lead and polypropylene can be used as a conductive material and an insulating material respectively. Said active and insulating materials alternate with each other to form electrodes and separators featuring appropriate thicknesses. The regions of the block made from an active material and the regions made from an insulating material are integral with each other along a plurality of separation surfaces which, in a preferred but non-limitative embodiment as shown in the figure, might be flat separation surfaces. According to other embodiments, said separation surfaces between electrodes and separators might assume different shapes (for instance spiral, cylindrical, flat with protrusions) in order to optimize the operation of the accumulator as a function of the shape of the outer case.

Also, without prejudice to the object of the invention, the block 10 might be implemented according to additive manufacturing technologies, such as, for example, multi-material 3D molding, in order for the layers to be integral with each other.

It is worth pointing out right away that one of the outstanding features of the accumulator according to the invention is in that the surface that separates the active material and the insulating material not necessarily shall be in correspondence with the boundary between one cavity 14 and the adjacent one, but it might rather be in an arbitrary position with respect to the geometrical structure of the block 10.

As already mentioned, geometrically wise the block 10 comprises a plurality of cavities 14 communicating with each other to form an alveolar structure. Every cavity 14 includes a wall 141 where at least one hole 142 is derived, so as to put the volume internal to said wall 141 in communication with the external volume. Preferably every cavity comprises a plurality of holes on its own wall so that, whenever the block 10 is dipped into an electrolyte, this one can flow internally to the block 10 and also pass through inside the cells. According to a first embodiment, every cell comprises a plurality of pairs of holes arranged on the wall 141 of the cell 14 so as to be opposed to each other.

Conveniently every cell 14 and every space between two adjacent cells also includes a hole on its top, so as to enable air to flow upwards while an electrolyte is being filled, thus preventing air bubbles from getting trapped in the structure.

Geometrically wise, according to a first embodiment illustrated in FIG. 3, every cell 14 can assume a spherical shape, and the cells 14 can be arranged in layers superimposed to each other, their centers being arranged vertically. According to another embodiment, the spherical cells might be arranged between each other in layers superimposed to and staggered from each other, the centers of the six cells about each of the neighbor cells forming a hexagon.

Other cell shapes might be used without leaving the scope of the invention, such as, for explanatory non-limitative purposes only, a tetrahedron, a cube, an octahedron, a dodecahedron, or an icosahedron.

The block 10 is thus inserted inside an outer case 20. Conveniently can the outer case be made from the same material as the separators and be integral therewith, so that the weight of the block 10 discharges onto the outer case 20 via the separators 13, and the electrodes do not support other loads but their own weight. For this purpose, the case can be manufactured jointly with the separators and the electrodes, by way of an additive manufacturing.

The case might also comprise, internally thereto, further different systems fostering the operation of the accumulator, such as a temperature variation system and electrical connections between the electrodes. The shape of the case might include holes, recesses, protrusions, or depressions which might be taken advantage of in assembling parts external to the accumulator, as well as inspection holes provided with transparent lids or removable lids.

Because of the geometrical composition of the electrodes and of the accumulator which comprises a plurality of hollow cells communicating with each other, an electrolyte can flow in the entire inner volume of the accumulator, this way operating as a thermal vector. Therefore, in a preferred embodiment, the accumulator according to the invention comprises pumping means and their respective communication ducts 40 between the inside and the outside of the electrolyte, configured in such a way as to make the electrolyte flow within the accumulator and make it possible to extract it, to send it to heat dissipation means, and then to re-insert it inside the case.

The dissipation means are either passive or active dissipation means of a type known in the present state of the art without leaving the object of the invention.

In accordance with a further embodiment, the accumulator according to the invention possibly comprises a set of ducts 50 inside the case, which define a volume, separated from that internally to which the electrolyte can flow, wherein a second liquid can flow to allow for a change of temperature of the component parts of the accumulator without having them mixed with the electrolyte.

Having described the geometry of the accumulator, it is now possible to describe the operation of the thus obtained accumulator.

Whenever an electrolyte is put inside the case 20 containing the block 10, it completely fills the volume left free by the material that forms the block 10, thus filling all cells. At this point, the accumulator operates according to the provisions of the state of the art, but it features the following advantages because of the way how it is implemented.

Because of their geometry, the electrodes are permeable to electrolyte flow and simultaneously they make it possible to recover the precipitate of the active material that forms during the operation, internally to said hollow cells 14. As a matter of fact, the precipitate will tend to settle on the lower surfaces of every cell, and consequently it will be available again for use. This allows to obviate the problem of region pulverization caused by the accumulator being overloaded and the consequent performance falling off. Also, this allows to prevent electrical bridges from being created by a random accumulation of the precipitate material.

Also, the just described geometrical consistency, which allows to optimize the contact surface between electrodes and electrolyte, makes it possible to obtain a greater electrical density per unit volume as compared to the embodiments known in the present state of the art.

1. A high capacity and resistance electric power accumulator comprising:
an outer insulating case configured for containing an electrolyte,
a block accommodated inside said insulating case, said block comprising a plurality of conductive material regions, said plurality of conductive material regions forming positive electrodes and negative electrodes, alternating with a plurality of insulating material regions, and forming separators, and
a plurality of adjacent cavities, said plurality of adjacent cavities forming a structure of said conductive material regions and spaces between said conductive material regions, each provided with a plurality of holes on wall thereof so that, whenever the block is dipped into the electrolyte, the electrolyte can flow and also enter the inside of the cavity,
wherein said cavities are aligned and superimposed to each other in such a way as to form an alveolar structure suitable for accommodating ducts passing through a portion of the block and configured in such a way as to make the electrolyte flow internally to the accumulator and to extract it therefrom.

2. The electric power accumulator according to claim 1, wherein the ducts passing through a portion of the block, are connected to means for extracting the electrolyte, sending the electrolyte to means for varying its temperature, and for re inserting the block in the case, said means being placed outside the accumulator.

3. The electric power accumulator according to claim 2, wherein the electrolyte temperature variation means are of a passive or active type.

4. (canceled)

5. (canceled)

6. The electric power accumulator according to claim 1, wherein every cavity and every space between two adjacent cavities have a hole on their top, so as to make it easier for gas to go out upwards and prevent air bubbles from remaining trapped inside said cavity.

7. The electric power accumulator according to claim 1, wherein every cavity of the conductive material regions forming the positive electrodes and the negative electrodes is permeable to electrolyte flow and is configured in such a way that the precipitate of the active material that forms during the operation can spread all over the inner surfaces of said cavities.

8. The electric power accumulator according to claim 1, wherein every cavity has a shape suitable for forming an alveolar structure by way of an alignment and superimposition of a plurality thereof.

9. The electric power accumulator according to claim 1, wherein every cavity has a shape selected from a group consisting of: a sphere, a cubic, a tetrahedron, an octahedron, a dodecahedron, and an icosahedron shape.

10. The electric power accumulator according to claim 1, wherein the outer insulating case is provided with at least one of holes, recesses, protrusions, and depressions which can be taken advantage of for assembling external components, as well as with inspection holes provided with transparent lids or removable lids.

11. A high capacity and resistance electric power accumulator comprising:
an outer insulating case configured for containing an electrolyte,
a block accommodated inside said insulating case, said block comprising a plurality of conductive material regions, said plurality of conductive material regions forming positive electrodes and negative electrodes, alternating with a plurality of insulating material regions, and forming separators, and
a plurality of adjacent cavities, said plurality of adjacent cavities forming a structure of said conductive material regions and spaces between said conductive material regions, each provided with a plurality of holes on wall thereof so that, whenever the block is dipped into the electrolyte, the electrolyte can flow and also enter the inside of the cavity,
wherein said cavities are aligned and superimposed to each other in such a way as to form an alveolar structure suitable for accommodating ducts passing through the complete block and configured in such a way as to define volumes separated from that delimited by the outer insulating case.

12. The electric power accumulator according to claim 11, wherein the ducts extend all throughout the body of the accumulator and operate inside the block capillary and in particular vascular way inside the electrodes and the separators.

13. The electric power accumulator according to claim 11, wherein the ducts, passing through the entire block, are connected to means for allowing a continuous flow of a fluid suitable for allowing an electrolyte temperature variation by induction, said means being placed outside the accumulator.

14. The electric power accumulator according to claim 11, wherein the ducts extend all throughout the body of the accumulator and operate inside the block capillary and in particular vascular way inside the electrodes and the separators.

15. The electric power accumulator according to claim 11, wherein every cavity and every space between two adjacent cavities have a hole on their top, so as to make it easier for gas to go out upwards and prevent air bubbles from remaining trapped inside said cavity.

16. The electric power accumulator according to claim 11, wherein every cavity of the conductive material regions forming the positive electrodes and the negative electrodes is permeable to electrolyte flow and is configured in such a way that the precipitate of the active material that forms during the operation can spread all over the inner surfaces of said cavities.

17. The electric power accumulator according to claim 11, wherein every cavity has a shape suitable for forming an alveolar structure by way of an alignment and superimposition of a plurality thereof.

18. The electric power accumulator according to claim 11, wherein every cavity has a shape selected from a group consisting of: a sphere, a cubic, a tetrahedron, an octahedron, a dodecahedron, and an icosahedron shape.

19. The electric power accumulator according to claim 11, wherein the outer insulating case is provided with at least one of holes, recesses, protrusions, and depressions which can be taken advantage of for assembling external components, as well as with inspection holes provided with transparent lids or removable lids.
